(19) United States
(12) Patent Application Publication
(10) Pub. No.: US 2006/0266381 A1
(43) Pub. Date: Nov. 30, 2006

(54) Commercial glassware dishwasher and related method

(76) Inventors: James E. Doherty, New Harbor, ME (US); Guy Rosenthal, Wheaton, IL (US); Klaus Padtberg, Offenburg (DE)

Correspondence Address: THOMPSON HINE LLP, P.O Box 8801, DAYTON, OH, 45401-8801, US

(21) Appl. No.: 11/140,633

(22) Filed: May 27, 2005

(51) Int. Cl. B08B 9/20; B08B 3/00; B08B 3/12

(52) U.S. Cl. 134/25.2; 134/26; 134/29; 134/56 D; 134/94.1; 134/184; 134/198

(57) ABSTRACT

Commercial, one-chamber glassware dishwasher with an electrolysis apparatus for the creation of alkaline water, by means of which drinking glasses are cleaned without the addition of detergent.

### TECHNICAL FIELD

The application concerns a commercial glassware dishwasher, which has a spray chamber and is designed for the batch loading and unloading of drinking glasses into/out of the spray chamber. Furthermore, the application concerns a method for the cleaning of drinking glasses in a commercial glassware dishwasher, which is designed for the batch loading and unloading of drinking glasses.

### BACKGROUND

Commercial glassware dishwashers, which are designed for the batch loading and unloading of a spray chamber with drinking glasses, are front-door machines, and can also be hood-type dishwashers. With front-door machines, the drinking glasses are placed in a basket or rack and the basket or rack, loaded with drinking glasses, is placed in the spray chamber through a front door, and after the cleaning, again removed through the front door. With hood-type dishwashers, the dish baskets or racks, loaded with drinking glasses, are manually pushed into the spray chamber from an entry side and after the ending of the cleaning program, manually removed from the spray chamber from an exit side. Front-door machines and hood-type dishwashers contain only one single spray chamber. The cleaning of drinking glasses usually takes place by at least one cleaning process, during which the drinking glasses are sprayed with a cleaning liquid (detergent), and at least one subsequent final rinse process, during which the drinking glasses are sprayed with a final rinse liquid. The final rinse liquid can be fresh water or a mixture of fresh water and a rinse agent. Commercial dishwashers, which are designed for batch loading, are also called batch dishwashers or batch ware washers.

U.S. Pat. No. 2,825,666 shows an apparatus for the cleaning of dishes, in particular, glassware. In order to impart the dishes with a special brilliance, it is proposed that the pH value of the final rinse water be controlled. For this, hard water is converted into soft acid final rinse solution by an electrodialysis method (apparatus for washing dishes, particularly glassware, that involves the control of the pH of the final rinse water, without the utilization of external chemical reagents. Herein the conversion of hard water into soft aqueous acid rinse solution is effected by an apparatus for treating the hard water that employs electrodialysis). U.S. Pat. No. 5,635,040, U.S. Pat. No. 6,004,439, and WO 98/50309 show an electrochemical cell for the treatment of water and aqueous solutions.

U.S. Pat. No. 5,947,135 (EP 0 761 156 B1) shows a dishwasher, in which dishes are first cleaned with acid-containing water and then with alkaline water.

Patent Abstracts of Japan, Publication No. 08 047 471 A, Application No. 06 187 407, shows a dishwasher for the cleaning of dishes without a dishwashing rinsing agent or a chemical. For this, water, basically ionized by electrolysis from service water, is formed for the cleaning of dishes and acid-containing, ionized water for the final rinsing of the dishes.

Patent Abstracts of Japan, Publication No. 08 047 473 A. Application No. 07 237 348, shows a dishwasher (batch dishwasher), which has a spray chamber with a door on the front side. Heated final rinse water or alkaline water, which is produced by an electrolysis apparatus, can be sprayed into the spray chamber. Acidic water produced by the electrolysis apparatus is disposed of.

Patent Abstracts of Japan, Publication No. 06 319 673 A, Application No. 05 132 700, describes a dishwasher, which is provided with an electrolysis apparatus, by means of which acidic water, from an externally supplied water, and alkali-ion water are produced for the reduction of the detergent consumption with oily dish stains (a dish washer capable of improving the washing effect against oil stains, reducing the detergent consumption. The dish washer is provided with an electrolytic tub electrolyzing the water fed from the outside to produce acid water and alkali ion water.).

US 2004/0 094 406 A1 discloses an electrolysis apparatus for the creation of strongly alkaline water, which can be used for a large number of purposes, for example, clothes washing machines and dishwashers.

It would be desirable to facilitate cleaning drinking glasses simply and sufficiently well without the use of a detergent and, in some cases, to also achieve suitable rinsing without the use of a rinse agent.

### SUMMARY

The invention uses, in a surprisingly simple manner, the effect of alkaline water for the complete cleaning of drinking glasses. Drinking glasses normally do not have oily stains. The invention makes it possible to clean such glasses without detergents.

For final rinsing, tap water or tap water mixed with a rinse agent may be used, or alternatively a purified water, such as tap water purified by reverse osmosis or tap water treated (deionized) by ion exchange with an ion exchange mass, may be used.

This is both an environmentally friendly as well as a low-cost method for the cleaning of drinking glasses.

### BRIEF DESCRIPTION OF THE DRAWINGS

FIG. 1 is a schematic depiction of a commercial glassware dishwasher, which is designed for the batch loading and unloading of drinking glasses into/out of a spray chamber; and

FIG. 2, is a schematic depiction of one variation of the dishwasher of FIG. 1.

### DETAILED DESCRIPTION

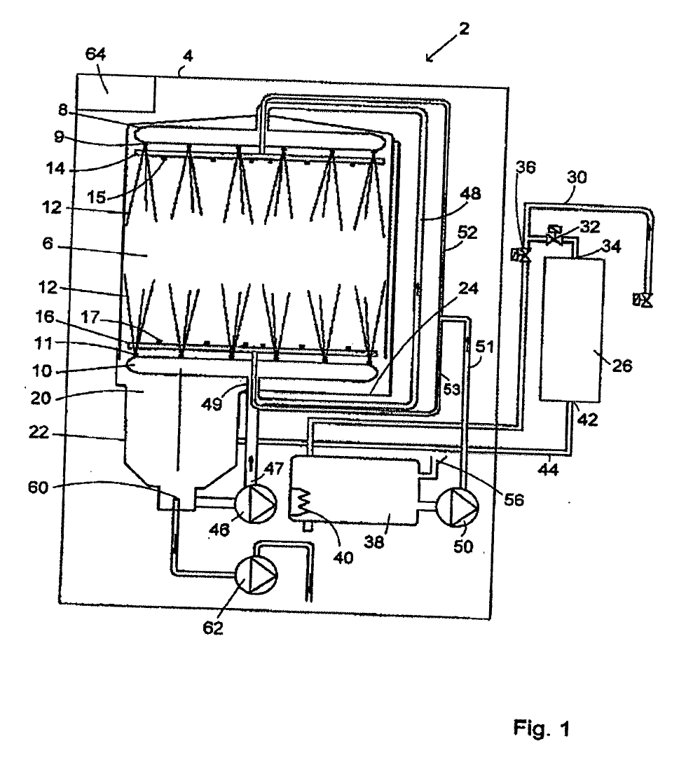

FIG. 1 shows a commercial glassware dishwasher 2 with a housing 4, in which a single spray chamber 6 is located. The spray chamber 6 contains upper and lower spray tubes 8 or 10, which have a large number of nozzles 9 and 11 for the spraying of cleaning liquid 12 from above and below onto the glassware, which is located in the spray chamber 6. Furthermore, upper and lower spray tubes 14 and 16 are located in the spray chamber 6, with a large number of nozzles 15 and 17 for the spraying of final rinse liquid from above and from below onto the glassware previously cleaned with cleaning liquid. For cleaning liquid and/or final rinse liquid, nozzles can also be located on at least one side of the spray chamber 6 and be directed transversely into the spray chamber.

The spray tubes 8, 10, 14, and 16 can be placed stationary or rotating. The spray tubes 14 and 16 for final rinse liquid can be integrated into the spray tubes 8 and 10 for cleaning liquid.

To carry out a cleaning and rinsing operation, the glassware is placed in the spray chamber 6, preferably in a basket or rack, through an opening. Subsequently, the cleaning program is started. During the course of the program, the glassware is first cleaned with cleaning liquid 12 from the nozzle tubes 8 and 10. Afterwards, the glassware is rinsed with final rinse liquid from the spray tubes 14, 16. At least one part of the bottom has a passage opening 20 to a tank or sump 22 located below the spray chamber 6. Cleaning liquid and final rinse liquid sprayed into the spray chamber 6 can drip into the tank 22, which is open above, or flow off, due to gravity, into the tank, via a bottom plate 24. After the final rinsing, the glassware is removed from the spray chamber 6.

Alkaline water without an addition of detergent is used as the cleaning liquid, which is produced by an electrolysis apparatus 26. The electrolysis apparatus 26 can be affixed within the housing 4 or outside on the housing or as an additional apparatus next to the glassware machine 2.

A water service connection 30 can be connected via a valve 32 to a water inlet 34 of the electrolysis apparatus and can be connected alternately via another valve 36 to a boiler 38, which preferably has an electrical heating element 40 for the heating of the water of the water service connection 30.

The alkaline water produced from the electrolysis apparatus 26 goes from an alkaline water outlet 42 of the electrolysis apparatus 26 via a conduit 44 into the tank or sump 22, whereby the tank 22 is filled with alkaline water, which has a pH value by means of which glassware is sufficiently cleaned without requiring a detergent or other chemicals or other additives. The cleaning liquid pumped from the tank 22 into the spray chamber 6 has a pH value of 9 or higher, preferably at least 11, and even more preferably, from 12 to 14. A suitable pH value of the alkaline water in tank 22 for the cleaning of glassware is, for example, 10.5. The alkaline water is preferably conveyed from the electrolysis apparatus 26 into the tank 22 with a pH value that is higher than the desired pH value of the cleaning liquid to be pumped from the tank 22 into the spray chamber 6 during cleaning.

During a washing program, this alkaline water is conveyed from the tank 22 by means of a pump 46, through alkaline water conduits 47, 48, 49 to the spray tubes 8 and 10 and via their nozzles 9 and 11 into the spray chamber 6 onto the glassware, as is shown schematically in FIG. 1 by means of sprayjets 12. By means of this cleaning process, the glassware of the spray chamber 6 is cleaned.

Subsequent to this cleaning process, a final rinse process takes place. During the final rinse process, water from the water service connection 30, heated in the boiler 38, is conveyed by a second pump 50 via cleaning liquid conduits 51, 52, 53 to the upper and lower spray tubes 14 and 16, and via their nozzles 15 and 17, sprayed into the spray chamber 6 onto the glassware. For this, clear water from the water service connection 30 (e.g., tap water) can be used or a final rinse agent can be added to this water through a final rinse inlet 56, which is shown schematically in FIG. 1 and only as an example at the boiler 48, but can also be at another site. If it is desired to substantially reduce spotting on the glasses while at the same time avoiding the need for the use of a rinse agent, the final rinse liquid maybe a purified water such as water formed by reverse osmosis or water which is treated (deionized) by ion exchange with an ion exchange mass. In this regard, a reverse osmosis unit or ion exchange unit may be provided affixed within the housing 4 or outside on the housing or as an additional apparatus next to the machine 2. Where purified water is fed to the electrolysis apparatus 26, it may also provide the added benefit of extending the life of electrodes within the apparatus 26.

The final rinse liquid sprayed in the spray chamber 6 drips and/or flows from the spray chamber 6 into the tank 22 and thus reduces the pH value of the water located in the tank 22. Therefore, the pH value in the tank 22 should first be increased by a regeneration process, once more, to a value suitable for the cleaning of glasses, before a subsequent cleaning process on a next batch of glassware is carried out. During the regeneration process, alkaline water, whose pH value is higher than the pH value mentioned for the cleaning of glasses, for example, 10.5, is conveyed from the electrolysis apparatus 26, via its alkaline water outlet 42 and the conduit 44, into the tank 22, for example, with a pH value between 11 and 13, for example 11.2, until the water in the tank 22 has once again reached the pH value of, for example, 10.5, which is required for the cleaning of glassware. Any excess water formed in the tank 22 is conducted away through a tank outlet 60, for example, by gravity or pumped away by another pump 62. An overflow path for carrying away such excess water might also be provided. In one embodiment the regeneration process may take place entirely after the end of the final rinse process and before the beginning of the subsequent cleaning process. In another embodiment, the regeneration process can take place at least partly during the final rinse process or the subsequent cleaning process, or both, so that the cycle time of the machine is not impacted (e.g., and the end of the final rinse process for one batch of glassware the machine is ready to begin the cleaning process for a subsequent batch of glassware as soon as the batch change is made). In one example, alkaline water can be delivered directly to the sump 22 whenever generated by the apparatus 26. In another example a tank to temporarily hold alkaline water can be positioned between the apparatus 26 and the sump 22 so that a sufficient reservoir of alkaline water is available when needed for introduction into the sump 22.

After the water in the tank 22 has again reached the pH value required for the cleaning of glassware, a cleaning process can again be carried out, in which alkaline water is conveyed by means of the pump 46 from the tank 22 via the spray tubes 8 and 10 into the spray chamber 6.

The electrolysis apparatus 26 may preferably be designed in such a way that it can selectively produce alkaline water with different pH values, as a function of the program course of the glassware dishwasher. The control of the electrolysis apparatus 26, the valves, and the pumps for the cleaning process, the final rinse process, and the regeneration process takes place by means of an electrical or electronic control device 64 of the glassware dishwasher 2.

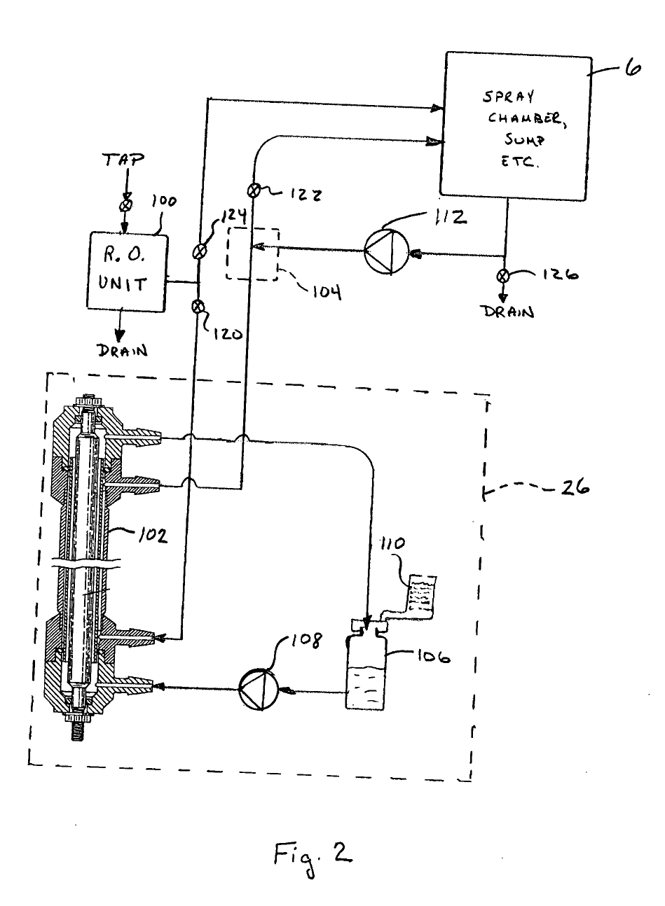

As previously noted, the water, which is conducted to the water service connection 30 for the operation of the glassware dishwasher 2, can be local water supply tap water or water formed by reverse osmosis or water which is treated (deionized) by ion exchange with an ion exchange mass. Referring now to FIG. 2, in one exemplary embodiment shown schematically, a tap water line feeds a reverse osmosis unit 100 that may be affixed within the housing 4 (FIG. 1) of the machine or outside on the housing or as an additional apparatus next to the machine. Purified water from the reverse osmosis unit 100 is delivered, via control valve 120, to the electrolysis apparatus 26, which in this embodiment takes the form of an electrolysis unit 102, similar to that described in U.S. Pat. No. 6,004,439. Other suitable electrolysis units are available and could be used. Purified water is fed to the input of the cathode side of the unit 102 and the catholyte output from the unit (e.g., water having a pH value of 9 or higher) is delivered to the spray chamber 6, via control valve 122, for use as previously described in connection with FIG. 1. A reservoir 104, such as a small tank, may be provided along the path to the spray chamber to allow a suitable amount of alkaline water to be maintained in the unit at all times. An anolyte reservoir 106, which in one example contains a sodium bicarbonate solution (i.e., sodium bicarbonate and water, preferably purified water), can be fed to the input of the anode side of the unit 102, as by a pump 108. Notably, the output of the anode side of the unit 102 is recirculated back to the reservoir 106. In this manner only catholyte is output by the apparatus 26. Moreover, providing purified water from the reverse osmosis unit 100 to the electrolysis unit 102 substantially reduces or eliminates contaminant build-up on the electrodes of the unit, allowing for greater operating time without service. An activated carbon trap 110 may be provided in connection with the reservoir 106.

As shown in FIG. 2, the liquid leaving the spray chamber and sump may be delivered to a drain via control valve 126 or, alternatively, a pump 112 and return path may be provided to enable liquid to be recirculated to the catholyte reservoir 104. In such an arrangement, at the conclusion of the cleaning process and before the rinsing process, the cleaning liquid, after passing through a filter, may be delivered to the reservoir 104. Such an embodiment would reduce the impact of rinsing water on the pH value of the cleaning liquid, potentially enabling a smaller capacity electrolysis unit 102 to be utilized. Purified water from the reverse osmosis unit 102 is delivered, via control valve 124, to the boiler associated with the spray chamber for use during the rinsing process.

The patent claims refer to examples of embodiments of the invention. The invention, however, may also concerns the use of each individual feature and subcombination of features, which are disclosed in the patent claims, the description, and/or the drawings.

What is claimed is:

1. A method for batch cleaning of glassware in a commercial glassware dishwasher having a spray chamber and a sump, the dishwasher designed for batch loading and unloading of glassware into or from the spray chamber, wherein, in accordance with the method, final rinse liquid is sprayed onto a first batch of glassware in the spray chamber during a final rinse process for the first batch of glassware and at least a part of the sprayed final rinse liquid arrives in the sump,
characterized in that
alkaline water is produced by an electrolysis apparatus and is delivered to the sump with a pH value of 9 or higher where it is mixed with the final rinse liquid, during a cleaning process for a second, subsequent batch of glassware in the spray chamber, cleaning liquid, which is a mixture of final rinse liquid and alkaline water, where the mixture has a pH value of 9 or higher, is pumped from the sump and is thereby sprayed into the spray chamber onto the second batch of glassware.

2. The method of claim 1,
characterized in that
the pH value of the alkaline water delivered to the sump is higher than the pH value of the mixture.

3. The method of claim 2,
characterized in that
the alkaline water is delivered to the sump during the final rinse process for the first batch of glassware and during the cleaning process for the second batch of glassware.

4. The method of claim 2,
characterized in that
the alkaline water is delivered to the sump after the end of the final rinse process for the first batch of glassware and before the start of the cleaning process of the second batch of glassware.

5. The method of claim 1,
characterized in that
after the final rinse process for the first batch of glassware, but before the cleaning process for the second batch of glassware, a regeneration process takes place during which at least some of the alkaline water is delivered to the sump, the pH value of the alkaline water delivered to the sump during the regeneration process is higher than the pH value of the mixture.

6. The method of claim 5,
characterized in that
the alkaline water is delivered to the sump both during the regeneration process and during the cleaning process for the second batch of glassware, the pH value of the alkaline water delivered during the regeneration process is higher than the pH value of the alkaline water delivered during the cleaning process for the second batch of glassware.

7. The method of claim 5,
characterized in that
the alkaline water is delivered to the sump both during the regeneration process and during one or both of the final rinse process for the first batch of glassware and the cleaning process for the second, subsequent batch of glassware.

8. The method of claim 1,
characterized in that
the pH value of alkaline water delivered to the sump is 10 or higher.

9. The method of claim 8,
characterized in that
the pH value of alkaline water delivered to the sump is 11 or higher.

10. The method of claim 9,
characterized in that
the pH value of alkaline water delivered to the sump is between about 12 and about 14.

11. The method of claim 8,
characterized in that
the pH value of the cleaning liquid pumped from the sump into the spray chamber is 10 or higher.

12. The method of claim 9,
characterized in that
the pH value of the cleaning liquid pumped from the sump into the spray chamber is 11 or higher.

13. The method of claim 10,
characterized in that
the pH value of the cleaning liquid pumped from the sump into the spray chamber is between about 12 and about 14.

14. The method of claim 1,
characterized in that
the final rinse liquid for the first batch of glassware is pure tap water or tap water mixed with a final rinse agent.

15. The method of claim 1,
characterized in that
the final rinse liquid for the first batch of glassware is one of (i) water formed by reverse osmosis of tap water or (ii) water formed by ion exchange treatment of tap water with an ion exchange mass, in either case free of any rinse agent.

16. A commercial glassware dishwasher containing a spray chamber, which can be batch loaded or unloaded with drinking glassware; a sump into which liquid sprayed in the spray chamber can return; a pump for the pumping of cleaning liquid from the sump through spray nozzles into the spray chamber; an electrolysis apparatus for the creation of alkaline water; a final rinse liquid supply for supplying final rinse liquid into the spray chamber for spraying onto drinking glassware; an electrical or electronic control device for the automatic control of functions of the glassware dishwasher;
characterized in that
the electrolysis apparatus is connected for supplying alkaline water with a pH of 9 or higher to the sump.

17. The glassware dishwasher of claim 16,
characterized in that
the electrolysis apparatus is connected for supplying alkaline water with a pH of at least 10 to the sump.

18. The glassware dishwasher of 16 claim 17,
characterized in that
the electrolysis apparatus is connected for supplying alkaline water with a pH of at least 11 to the sump.

19. The glassware dishwasher of claim 16,
characterized in that
the electrolysis apparatus is connected for supplying alkaline water with a pH of between about 12 and about 14 to the sump.

20. The glassware dishwasher of claim 16,
characterized in that
the control device and the electrolysis apparatus are operable such that after a final rinse process, but before a subsequent cleaning process, a regeneration process is carried out, in which by means of the electrolysis apparatus, alkaline water is conveyed to the sump with a pH value of higher than the pH value of cleaning liquid delivered through spray nozzles during the subsequent cleaning process.

21. The glassware dishwasher of claim 20,
characterized in that
the control device and the electrolysis apparatus are operable such that by means of the electrolysis apparatus, during both the regeneration process and the subsequent cleaning process, alkaline water is produced and supplied to the sump, wherein the pH value of water supplied to the sump during the regeneration process is higher than the pH value of water supplied to the sump during the subsequent cleaning process.

22. The glassware dishwasher of claim 16,
characterized in that
a water supply inlet connection is provided to deliver water to both an inlet of the electrolysis apparatus for production of alkaline water and to an inlet of the final rinse liquid supply, via at least one flow control device.

23. The glassware dishwasher of claim 16,
characterized in that
a water purification unit is provided to deliver water to both an inlet of the electrolysis apparatus for production of alkaline water and to an inlet of the final rinse liquid supply.

24. The glassware dishwasher of claim 23,
characterized in that
the water purification unit comprises a reverse osmosis unit.

25. A commercial glassware dishwasher containing a spray chamber, which can be batch loaded or unloaded with drinking glassware; a sump into which liquid sprayed in the spray chamber can return; a pump for the pumping of cleaning liquid from the sump through spray nozzles into the spray chamber; an electrolysis apparatus for the creation of alkaline water; a final rinse liquid supply for supplying final rinse liquid into the spray chamber for spraying onto drinking glassware; an electrical or electronic control device for the automatic control of functions of the glassware dishwasher;
characterized in that
a water purification unit is provided to deliver purified water to both an inlet of the electrolysis apparatus for production of alkaline water and to an inlet of the final rinse liquid supply.

26. The glassware dishwasher of claim 24,
characterized in that
the water purification unit comprises a reverse osmosis unit.
